(19) United States
(12) Patent Application Publication
(10) Pub. No.: US 2007/0239631 A1
(43) Pub. Date: Oct. 11, 2007

(54) Method, apparatus and computer program product for generating a graphical image string to convey an intended message

(75) Inventor: Kongqiao Wang, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/391,930

(22) Filed: Mar. 28, 2006

(51) Int. Cl. G06F 15/18

(52) U.S. Cl. 706/12

(57) ABSTRACT

A method is provided for generating a graphical image string that is capable of conveying an intended message. In particular, a user is enabled to select one or more graphics from a graphic language database, wherein the annotations (or descriptions) associated with each graphic selected can be combined to convey the intended message. A common sense augmented translation of the combined graphics can be performed in order to convert the graphical image string into a text message. In addition, the opposite translation may similarly be performed in order to generate a graphical image string, or graphic SMS or MMS message, IM, E-mail, or the like, from a text message. A corresponding electronic device, network entity, system and computer program product are likewise provided.

### FIELD OF INVENTION

Exemplary embodiments of the present invention relate generally to text messaging and, in particular, to creating graphical messages that can be communicated, as is, or translated into corresponding text messages.

### BACKGROUND OF THE INVENTION

For many people text messaging is a fast, fun and inexpensive way to communicate with friends, family members and colleagues. Using applications including, for example, Short Message Service (SMS) and Instant Message (IM) service, people are able to use their portable electronic devices (e.g., cellular telephones, personal digital assistants (PDAs), laptops, pagers, and the like) to compose short, quick messages that can be communicated to one another at any time and from nearly anywhere. As a result, communicating via text messaging is very convenient and has become very popular.

For some people, however, composing and/or reviewing text messages may be difficult, if not impossible. For instance, a person who is illiterate, or even semi-literate, is likely to have a difficult time drafting text messages, as well as reviewing a text message he or she has received. In addition, certain people may consider text messaging somewhat boring. This may be true particularly for children or teenagers.

A need, therefore, exists for a messaging scheme that not only enables people who have a difficult time reading and/or writing to still be able to communicate with friends, family members and colleagues in a fast, fun and inexpensive manner, but also provides a new, fun and exciting way to send and receive messages that would appeal to kids of all ages.

### BRIEF SUMMARY OF THE INVENTION

In general, exemplary embodiments of the present invention provide an improvement over the known prior art by, among other things, providing a scheme for generating a graphical image string that is capable of conveying an intended message. In particular, the method of exemplary embodiments enables a user to select one or more graphics from a graphic language database, wherein the annotations (or descriptions) associated with each graphic selected can be combined to convey the intended message. In one exemplary embodiment, a common sense augmented translation of the combined graphics can be performed in order to convert the graphical image string into a text message. In addition, the opposite translation may similarly be performed in order to generate a graphical image string, or graphic SMS (Short Message Service) or MMS (Multimedia Messaging Service) message, IM (Instant Message), E-mail, or the like, from a text message.

In accordance with one aspect of the invention, a method is provided for generating a graphical image string capable of conveying an intended message. In one exemplary embodiment, the method includes: (1) accessing a graphical language database comprising a plurality of graphics, wherein one or more annotations are associated with respective ones of the graphics; (2) selecting one or more graphics from the graphic language database, such that a combination of at least one of the annotations associated with the selected graphics is capable of conveying the intended message; and (3) combining the selected graphics into a graphical image string.

In one exemplary embodiment, the method further includes retrieving one or more annotations associated with the selected graphics. The method of this embodiment may further include translating the graphical image string into a text message. In one exemplary embodiment, translating the graphical image string into a text message includes determining which of the one or more annotations associated with respective graphics of the graphical image string conveys the intended message, combining those annotations determined to convey the intended message, and formatting the combined annotations into a text message. Determining which of the annotations associated with respective graphics of the string conveys the intended message may, in one exemplary embodiment, involve accessing a common sense database comprising a plurality of annotations, as well as one or more attributes corresponding with respective annotations, comparing one or more attributes corresponding with respective annotations associated with respective graphics of the graphical image string, and selecting at least one of the annotations for respective graphics of the string based at least in part on the comparison of the attributes.

In one exemplary embodiment, the intended message corresponds with a text message to be translated into a graphical image string. The method of this exemplary embodiment may, therefore, also include extracting a context of the intended message from the text message. In this exemplary embodiment, selecting one or more graphics comprises selecting one or more graphics, such that a combination of at least one of the annotations associated with the selected graphics corresponds with the extracted context.

According to another aspect of the invention, an electronic device is provided for generating a graphical image string capable of conveying an intended message. In one exemplary embodiment the mobile device includes a processor and a memory in communication with the processor that stores an application executable by the processor, wherein the application is configured, upon execution, to: (1) access a graphic language database comprising a plurality of graphics, wherein one or more annotations are associated with respective ones of the graphics; (2) enable a user associated with the electronic device to select one or more graphics from the graphic language database, such that a combination of at least one of the annotations associated with the selected graphics is capable of conveying the intended message; and (3) combine the selected graphics into a graphical image string.

In one exemplary embodiment, the application is further configured, upon execution, to translate the graphical image string into a text message. In another exemplary embodiment, the electronic device further includes an input device in communication with the processor and configured to enable the user to input one or more words into the graphical image string. In yet another exemplary embodiment, the application is further configured, upon execution, to receive a text message, and to translate the text message into a graphical image string.

According to yet another aspect of the invention, an apparatus is provided that is capable of converting a graphical image string into a text message. In one exemplary embodiment, the apparatus includes a processor and a memory in communication with the processor that stores an application executable by the processor, wherein the application is configured, upon execution, to: (1) receive a graphical image string comprising a combination of one or more graphics selected and combined to convey an intended message; (2) access one or more annotations corresponding with respective graphics of the graphical image string; (3) select at least one of the corresponding annotations for respective graphics of the graphical image string based at least in part on a comparison of one or more attributes associated with respective annotations; and (3) combine the selected annotations into a text message.

In one exemplary embodiment the application is further configured, upon execution, to receive a text message and to translate the text message into a graphical image string. The application of this exemplary embodiment may, therefore, be further configured, upon execution, to extract a context of the text message, to access a graphic language database comprising a plurality of graphics, wherein one or more annotations are associated with respective ones of the graphics, to select one or more graphics from the graphic language database, such that a combination of at least one of the annotations associated with the selected graphics is capable of conveying the context of the text message, and to combine the selected graphics into a graphical image string.

In one exemplary embodiment, the apparatus comprises at least one of a Common Sense Augmented Translation (CSAT) server or an electronic device.

In accordance with another aspect of the invention, a system is provided for generating a graphical image string capable of conveying an intended message. In one exemplary embodiment, the system includes a graphic language database and an electronic device configured to access the graphic language database. The graphic language database comprises a plurality of graphics, wherein one or more annotations are associated with respective ones of the graphics. The electronic device, in turn, is configured to enable a user associated with the electronic device to select one or more graphics from the graphic language database, such that a combination of at least one of the annotations associated with selected graphics is capable of conveying the intended message. The electronic device is further configured to combine the selected graphics into a graphical image string.

In one exemplary embodiment, the system further includes an annotation database comprising the annotations associated with respective ones of the graphics. The electronic device of this exemplary embodiment is further configured to access the annotation database and to retrieve the one or more annotations associated with the selected graphics.

In another exemplary embodiment, the electronic device is further configured to translate the graphical image string into a text message. In yet another exemplary embodiment, the system further includes a network entity, wherein the electronic device is further configured to transmit the graphical image string and the network entity is configured to receive the graphical image string from the electronic device and to translate the graphical image string into a text message.

The system of one exemplary embodiment further includes a common sense database accessible by the electronic device. The common sense database of this exemplary embodiment comprises a plurality of annotations and one or more attributes corresponding with respective annotations.

In one exemplary embodiment, the electronic device is further configured to receive a text message and to translate the text message into a graphical image string. In another exemplary embodiment, the network entity is configured to receive the text message and to translate the text message into a graphical image string.

In accordance with yet another aspect of the invention a computer program product is provided for generating a graphical image string capable of conveying an intended message. The computer program product contains at least one computer-readable storage medium having computer-readable program code portions stored therein. The computer-readable program code portions of one exemplary embodiment include: (1) a first executable portion for accessing a graphic language database comprising a plurality of graphics, wherein one or more annotations are associated with respective ones of the graphics; (2) a second executable portion for enabling a user associated with the electronic device to select one or more graphics from the graphic language database, such that a combination of at least one of the annotations associated with the selected graphics is capable of conveying the intended message; and (3) a third executable portion for combining the selected graphics into a graphical image string.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an exemplary graphical image string, or graphic SMS or MMS message, IM, E-mail, or the like, which may be created in accordance with exemplary embodiments of the present invention;

FIG. 2 is a flowchart illustrating the steps which may be performed in order to generate a graphic SMS or MMS message, IM, E-mail, or the like, and to create a text message from the graphic message, where desired, in accordance with an exemplary embodiment of the present invention;

FIG. 3 is a block diagram further illustrating the process of generating a graphic SMS or MMS message, IM, E-mail, or the like, and creating a text message from the graphic message in accordance with exemplary embodiments of the present invention;

FIG. 4 is a flow chart illustrating the steps which may be performed in order to translate a text message into a graphic message (e.g., a graphic SMS or MMS message, IM, E-mail, or the like) in accordance with an exemplary embodiment of the present invention;

FIG. 5 illustrates another exemplary graphical image string, which may be created in accordance with exemplary embodiments of the present invention;

FIG. 6 is a block diagram of one type of system that would benefit from exemplary embodiments of the present invention;

FIG. 7 is a schematic block diagram of an entity capable of operating as a Common Sense Augmented Translation server, or similar network entity, in accordance with exemplary embodiments of the present invention; and

FIG. 8 is a schematic block diagram of a mobile station capable of operating in accordance with an exemplary embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

In general, exemplary embodiments of the present invention provide a common sense augmented Short Message Service (SMS). Multimedia Messaging Service (MMS), Instant Message (IM), E-mail, or the like, scheme that enables a user to string together a group of graphical images in order to convey a message to another party, as opposed to typing the actual message, for example, on a keypad.

The graphical SMS, MMS, IM, E-mail, or the like, scheme of exemplary embodiments enables illiterate and semi-literate people to more easily communicate text messages using their electronic devices. The graphical scheme is also a fun and entertaining way for kids of all ages to communicate with one another.

In order to implement the graphic scheme, a user accesses a graphic language database composed of a large number of annotated graphical images. Each image or graphic corresponds to and is annotated with one or more unique words or phrases that can be clearly ascertained from the graphic. For example, a graphic of a motor vehicle may be annotated with the words “car,” “driving,” “traveling” and/or “speeding,” and/or, depending upon the type of car shown, “truck,” “van,” “limousine,” or the like. In one exemplary embodiment, the various annotations may be displayed beneath, or otherwise in the vicinity of, the graphical image. Alternatively, the user may need to select, by for example clicking on, highlighting or simply placing a cursor over, the graphical image in order to display the applicable annotations.

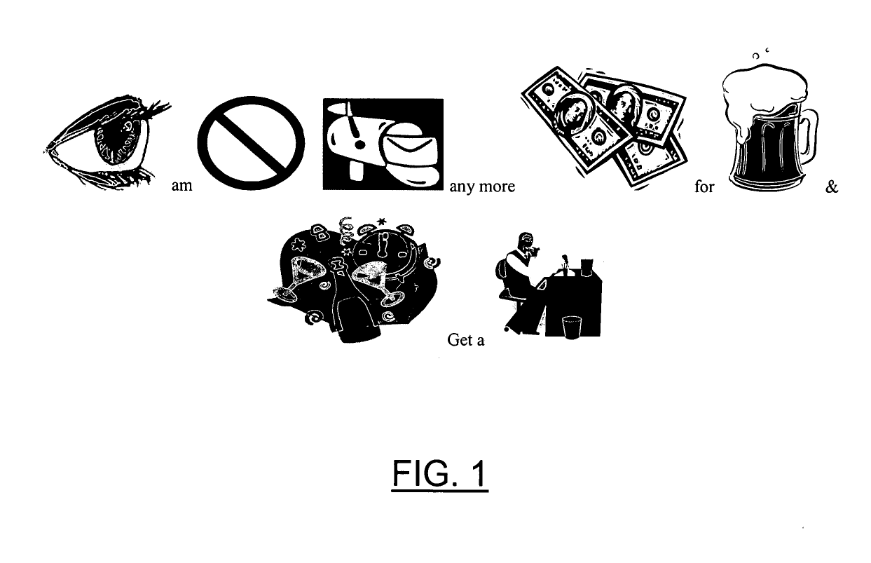

The user selects one or more graphical images from the graphic language database and strings them together in order to create a sentence or an entire message. In addition, the user may insert words throughout the string of graphics in order to more clearly convey the message. FIG. 1 illustrates an exemplary string of graphical images and text intended to convey the message “I am not sending any more money for beer and partying. Get a job!”

The user can then either transmit the actual graphical string to the intended recipient, or he or she can opt to have the graphical images translated into a standard text message that is then conveyed to the receiving party. In one exemplary embodiment, the electronic device itself will perform this translation. Alternatively, a Common Sense Augmented Translation (CSAT) server, or similar network entity, may be configured to receive a graphical image string and convert it into a text message. The CSAT server and/or the electronic device may similarly be capable of translating or converting a text message generated by a user in the typical fashion into a graphic SMS or MMS message, IM, E-mail, or the like, (i.e., a string of graphical images and text).

Method of Creating a Graphical Image String and Translating String into a Text Message:

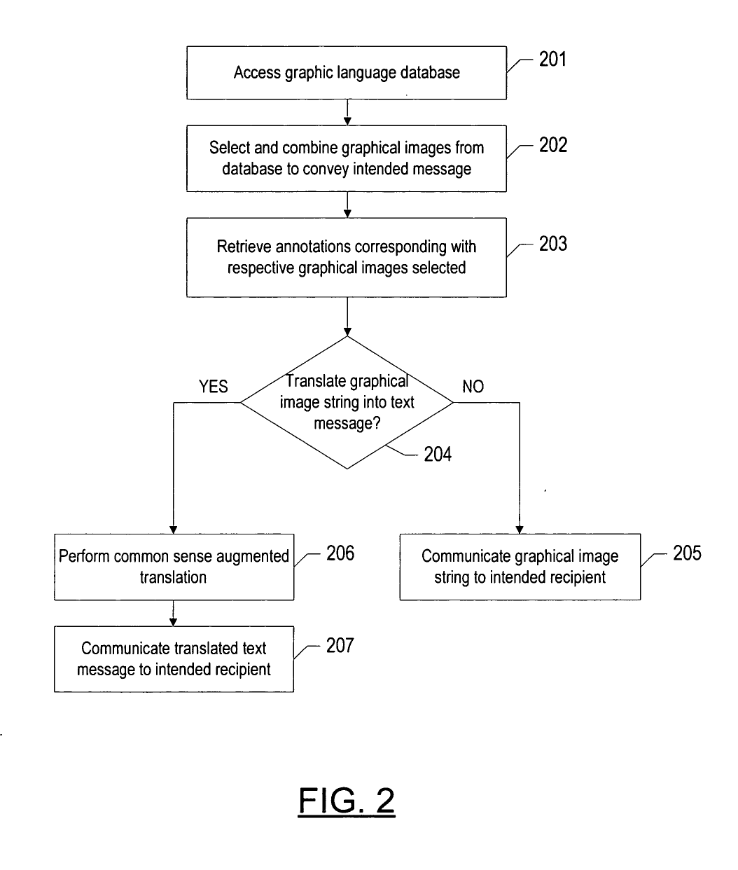

Reference is now made to FIG. 2, which provides a flowchart illustrating the steps which may be taken in order to implement the graphical scheme of exemplary embodiments of the present invention. As shown, and as discussed above, the process begins at Step 201 where a user consults or accesses a graphic language database composed of a plurality of annotated graphical images. This graphic language database may, for example, be associated with and maintained by the user's network operator. In order to access the database, the user may, therefore, be required, for example, to browse to a web site associated with the network operator. Alternatively, the user may have previously downloaded the database to his or her electronic device, enabling the user to access the database directly without being connected to a communications network.

Once the user has accessed the database, he or she, in Step 202, selects and combines one or more images from the database that will convey an intended message. In one exemplary embodiment, a user interface may be provided that enables the user to perform this step. For example, the user interface may enable the user to drag and drop the selected graphics into a message window, to rearrange the images into a desired order, and to, where necessary or desired, add words or phrases before, after and/or in between the images.

As the user selects various graphics from the database, the annotations corresponding with respective graphics are simultaneously retrieved and at least temporarily stored to the electronic device. (Step 203). Although the annotations and the graphics may be stored in the same database, in one exemplary embodiment, the annotations are maintained in a database separate from the graphic language database, referred to herein as the “annotation database,” which is composed of the annotations along with the requisite correlating information (i.e., a mapping of the graphics to their respective annotations). The annotation database, like the graphic language database, may be maintained on a server associated with the network operator and accessible via a corresponding web site, or the annotation database may have been downloaded directly to the user's electronic device along with the graphic language database.

Once the user has completed his or her graphic SMS or MMS message, IM, E-mail, or the like, it is determined, in Step 204, whether he or she wishes to transmit the graphical image string itself to the intended recipient, or, instead, to have the graphical image string translated into a text message prior to being sent. Again, the user generally provides input, such as via the user interface, that indicates if the graphic message should be transmitted or first translated prior to transmission. Where the user decides that he or she does not want the graphical image string translated into a text message, the graphical image string is communicated as is to the intended recipient. (Step 205).

Alternatively, where the user designates that he or she would like to have the graphical image string translated into a text message, the process continues to Step 206, where a common sense augmented translation of the image string is performed. In one embodiment, each graphical image has a single word or phrase associated with the image. In this instance, the string of graphical images can be translated by replacing each graphical image by its associated word or phrase. Alternatively, multiple words or phrases may be associated with one or more of the graphical images such that a determination must be made based upon the context, such as the contextual relationship between the plurality of graphical images, as to which words or phrases to select for translation purposes. In this alternative embodiment, the common sense augmented translation may employ a database, such as a common sense database, that is composed of a large pool of words and expressions (i.e., concepts) that are each defined by one or more attributes. These concepts include the annotations, or words or phrases, associated with respective graphical images. The common sense database defines the correlation between different concepts and their attributes and uses this correlation to infer or assume what the user intends to convey. In other words, the similarities between any two concepts can be calculated, such that, based on these similarities, the database can infer the references of the concept in the database.

For example, the word or concept “Nokia” may be defined with several attributes, such as “manufacturer,” “mobile,” “communication,” “tool” and/or “Finland.” In a similar manner, the word or concept “Motorola” may be defined with the attributes “manufacture,” “mobile,” “communication,” “tool” and/or “America.” Because the similarities between the attributes of these two concepts are quite extensive, when “Nokia” is selected from the common sense database, “Motorola” may also be selected as a reference of “Nokia.” As another example, the correlation of the context of various terms or concepts may also be emphasized. To illustrate, the term “eat” may be categorized by a common sense database as relevant to the terms “bread,” “rice”, “pizza,” or the like, just to name a few. Similarly, the term “boat” may be relevant to “row,” “lake,” “river,” or the like. When one of those terms appears, for example, as one of the annotations associated with a graphic in a graphical image string, it can be assumed that one of the other relevant terms is likely to precede or follow that term in the phrase or string.

According to exemplary embodiments of the present invention, the electronic device will consult the annotations retrieved in Step 203 based upon their correspondence with respective graphics that have been selected and combined by the user into the graphical image string in Step 202, and will determine, using the common sense, or similar, database, which annotation should be used for each graphic based upon the contextual relationship between the graphics. In other words, where a particular graphic has more than one corresponding annotation (e.g., the motor vehicle graphic discussed above, which may be associated with “car,” “driving,” “traveling,” “speeding,” “truck,” “van,” “limousine,” or the like), the electronic device will use the common sense database to compare the annotations of that graphic (and, in particular, the attributes of the annotations) with those of the surrounding graphics (e.g., the graphics that precede and follow the graphic in question) to determine which annotation shares the most attributes in common with those of the surrounding graphics and should therefore be used in the translation. The determination is said to be based on “common sense.” (For more information on “common sense” technology, see http://csc.media.mit.edu/CSAppsOverview.htm).

Once the appropriate annotations have been selected for the respective graphics in the graphical image string, the selected annotations can then be composed into one or more sentences based on the appropriate syntax, grammar, and the like. The translated text message is then communicated to the intended recipient, in Step 207.

In one exemplary embodiment, instead of the electronic device itself performing the common sense augmented translation, this step (Step 206) is performed by a Common Sense Augmented Translation (CSAT) server, or similar network entity. The CSAT server, like the graphic language and annotation databases, may, for example, be associated with and maintained by the electronic device user's network operator. Where the CSAT server performs the translation, following Step 204, if it is determined that the user does wish to translate the graphical image string into a text message, the electronic device transmits the graphical image string, along with the retrieved annotations, to the CSAT server. The CSAT server will then consult the common sense database in order to select the appropriate annotations, and will compose the one or more sentences of the message for return to the electronic device or communication to the intended recipient.

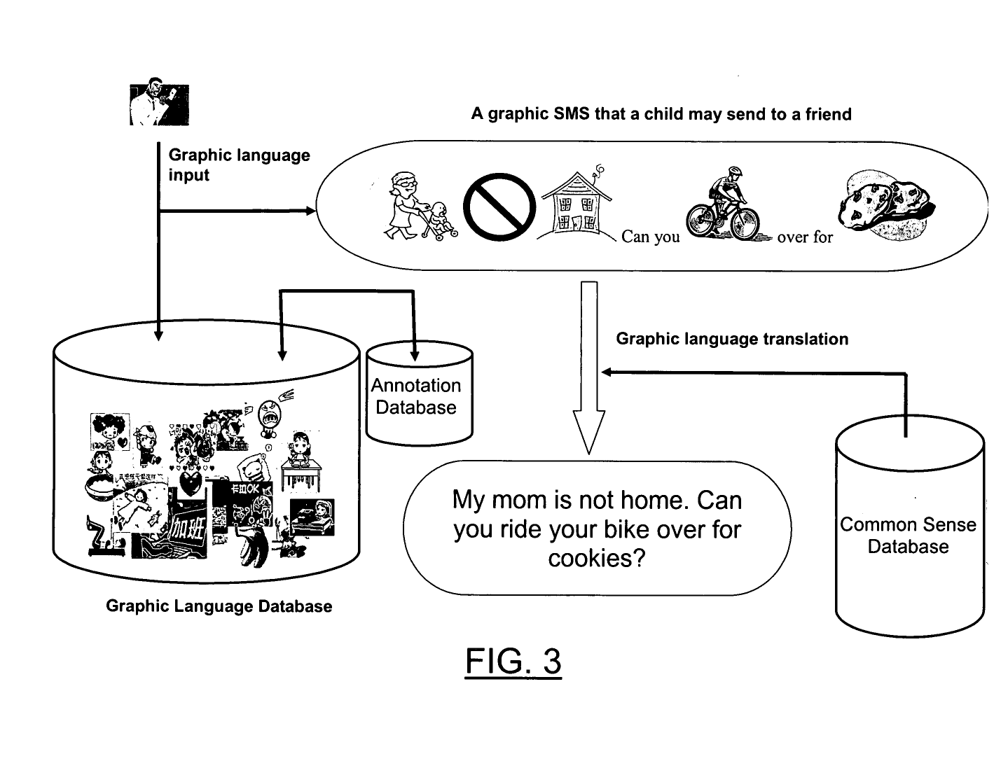

FIG. 3 provides an overall block diagram illustrating the method described above, wherein a user generates a graphic SMS or MMS message, IM, E-mail, or the like, in order to convey the message “My mom is not home. Can you ride your bike over for cookies?”

Method of Creating Graphical Image String from Text Message:

In another exemplary embodiment of the present invention, the opposite process may be desired. In particular, a user may wish to input a text message and then have that text message translated into a graphical image string prior to being communicated to the intended recipient. Alternatively, the party receiving a text message may desire to have the text message he or she received translated into a graphical image string (i.e., the translation may be performed at either the transmitting or the receiving end of the communication). This may be beneficial, for example, where the party receiving, as opposed to the party transmitting, the SMS or MMS message, IM, E-mail, or the like, is illiterate or semi-literate.

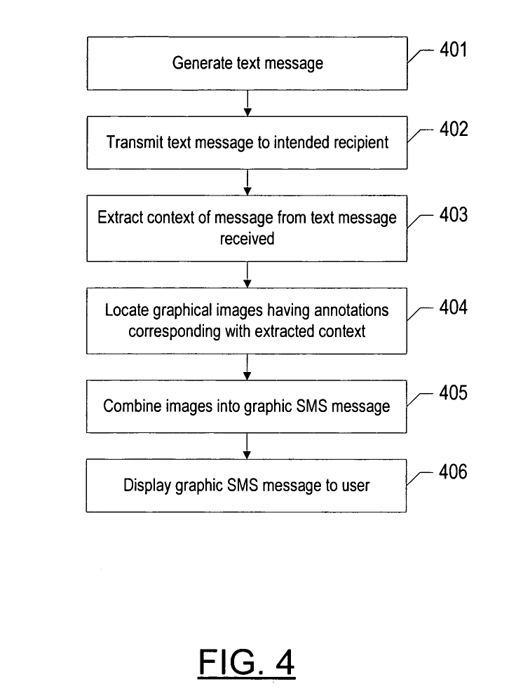

FIG. 4 illustrates the steps which may be taken in order to implement this exemplary embodiment of the present invention, assuming that the party receiving the text message is the party that is capable of and desires to have the text message translated into a graphical image string. As shown, the process begins at Step 401 where a user generates a text message, for example, by typing in the message using his or her electronic device keypad. For example, the user may type “I am sad and want to get some ice cream.”

The next step is to transmit the text message to the intended recipient. (Step 402). Note, of course, that this step would not be performed at this point in the process, where the party transmitting the message is the party with the capability and desire to translate the text message into a graphical image string since the party transmitting the message would already have performed the translation. In addition, as with the process illustrated and described in FIG. 2, where a CSAT server is used to perform the common sense augmented translation instead of the electronic device itself, Step 402 would instead comprise transmitting the text message to the CSAT server for translation prior to being transmitted to the recipient, and not the intended recipient.

Returning to FIG. 4, upon receipt of the text message, the receiving party electronic device, in Step 403, extracts from the text message the context of the message. This may be done, for example, using a database, such as the common sense database. To illustrate, in one exemplary embodiment, extracting the context of the text message may involve removing all prepositions, conjunctions, and the like, from the text message, leaving only nouns and verbs. For example, using this method, the context of the above-referenced text message may be “I,” “sad” and “ice cream.”

Based on the extracted context, the electronic device of the recipient in this embodiment (or the CSAT server associated with the electronic device of the recipient, whichever is performing the translation) then accesses the graphic language database and the annotation database in order to locate the graphical images having annotations that correspond with the extracted context. (Step 404). Where more than one graphical image can be associated with a particular word or phrase, this step may involve selecting which of the graphical images to select. In one exemplary embodiment, the user may be able to manually select which graphical image to use. Alternatively, the selection may be performed automatically based on various criteria.

Once the graphical images have been located, the images are combined into a graphic SMS or MMS message, IM, E-mail, or the like, which may or may not also include words or phrases interspersed throughout the string of graphical images in order to interconnect the graphical images. (Step 405). This graphic message is then displayed to the recipient, in Step 406. Where either the CSAT server or the party who generated the text message are responsible for performing the translation of Steps 403-405, a step of transmitting the graphic SMS message to the intended recipient would be performed prior to Step 406.

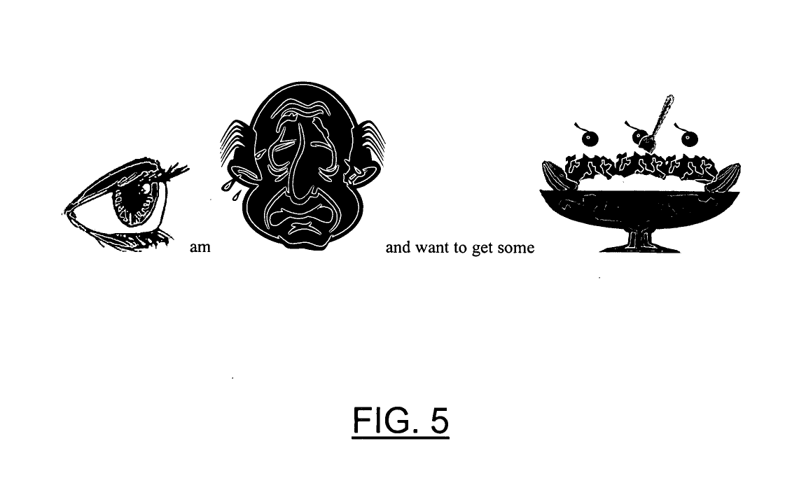

FIG. 5 provides an illustration of one example of a graphical image string or graphic SMS or MMS message, IM, E-mail, or the like, that may have been generated and displayed based on the text message “I am sad and want to get some ice cream.”

Overall System and Mobile Device:

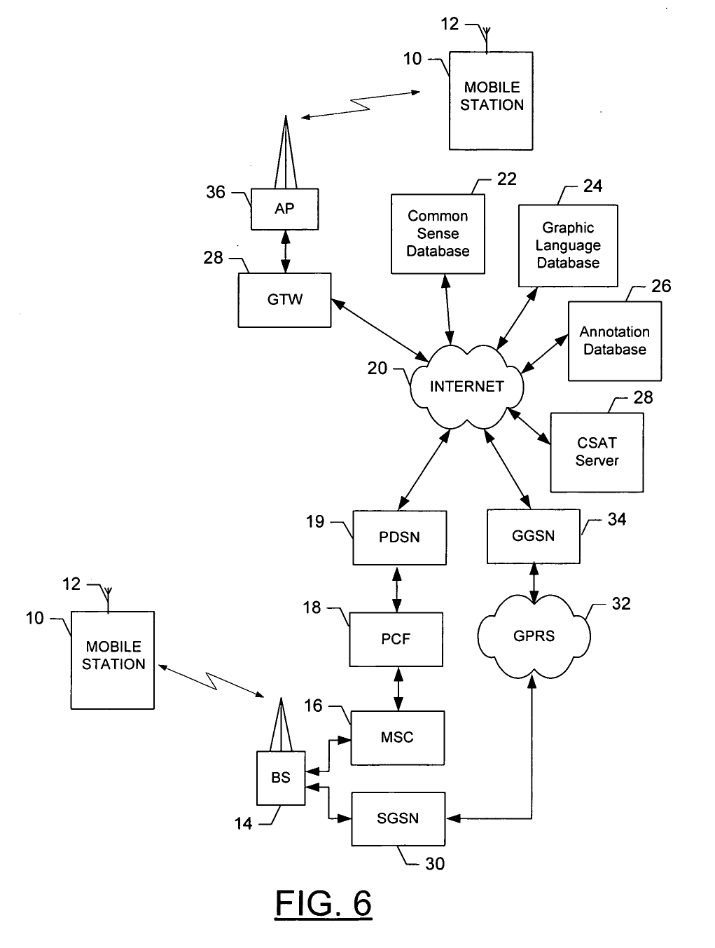

Referring to FIG. 6, an illustration of one type of system that would benefit from exemplary embodiments of the present invention is provided. As shown in FIG. 6, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include a CSAT server 28. As will be appreciated, the processing elements can comprise any of a number of processing devices, systems or the like capable of operating in accordance with embodiments of the present invention. Additionally, various databases, typically embodied by servers or other memory devices, can be coupled to the mobile station 10 via the Internet. For example, the databases can include a common sense database 22, a graphic language database 24 and/or an annotation database 26.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1 G), second-generation (2 G), 2.5 G and/or third-generation (3 G) mobile communication protocols or the like. More particularly, one or more mobile stations may be coupled to one or more networks capable of supporting communication in accordance with 2 G wireless communication protocols IS-136 (TDMA), GSM, and IS-95 (CDMA). Also, for example, one or more of the network(s) can be capable of supporting communication in accordance with 2.5 G wireless communication protocols GPRS, Enhanced Data GSM Environment (EDGE), or the like. In addition, for example, one or more of the network(s) can be capable of supporting communication in accordance with 3 G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the APs can be directly coupled to the Internet. In one embodiment, however, the APs are indirectly coupled to the Internet via a GTW 28. As will be appreciated, by directly or indirectly connecting the mobile stations and the processing elements and databases (e.g., common sense database 22, graphic language database 24, annotation database 26 and/or a CSAT server 28) and/or any of a number of other devices to the Internet, whether via the APs or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 6, in addition to or in lieu of coupling the mobile stations 10 to one or more processing elements and/or databases (e.g., common sense database 22, graphic language database 24, annotation database 26 and/or a CSAT server 28) across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

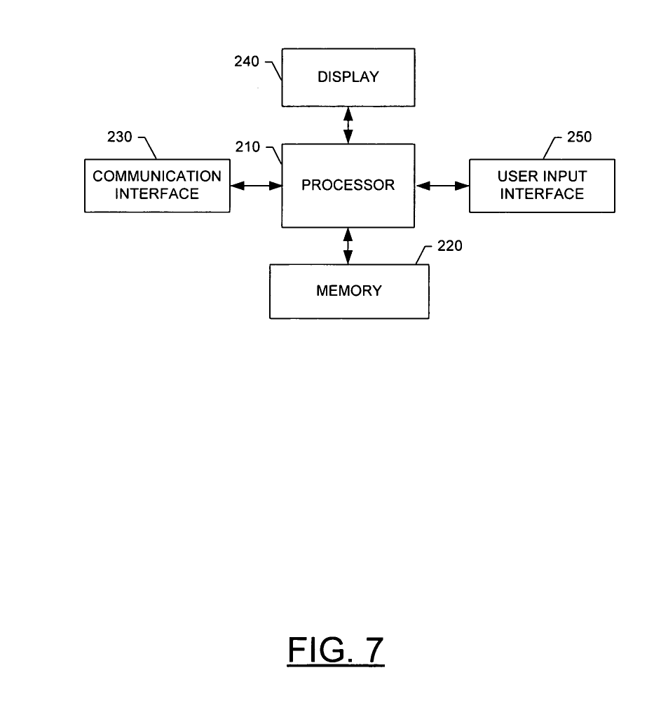

Referring now to FIG. 7, a block diagram of an entity capable of operating as a CSAT server 28 is shown in accordance with one embodiment of the present invention. The entity capable of operating as a CSAT server 28 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a CSAT server 28 can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

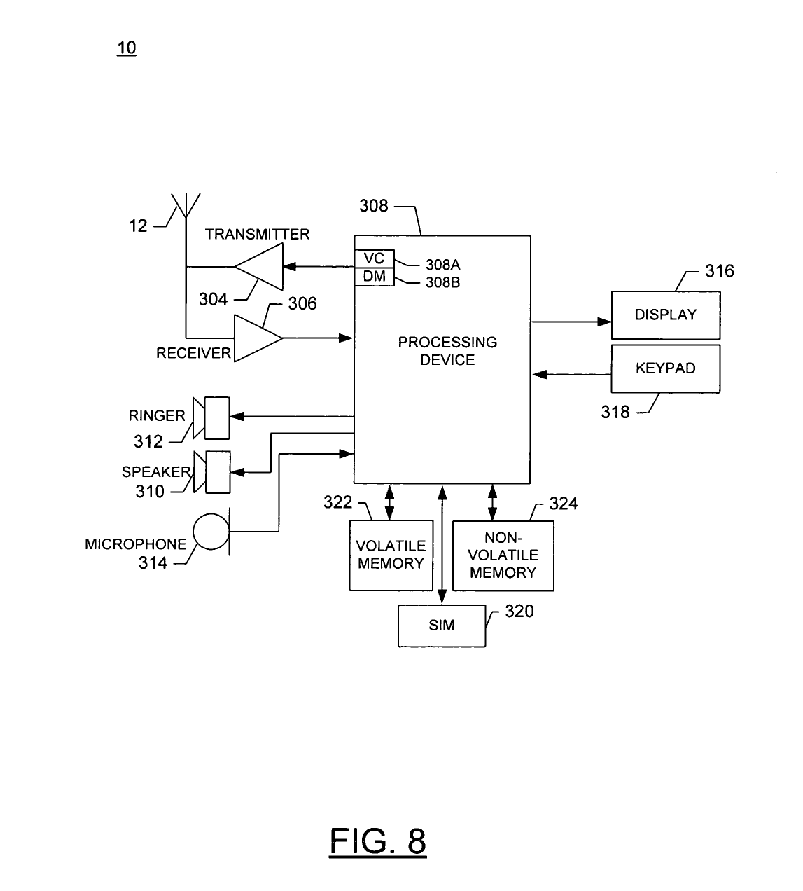

Reference is now made to FIG. 8, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, in addition to an antenna 302, the mobile station 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2 G), 2.5 G and/or third-generation (3 G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content such as a common sense database 22, a graphic language database 24 and/or an annotation database 26. The memory may, for example, store computer program code for an application and other computer programs. For example, in one embodiment of the present invention, the memory may store computer program code for accessing a graphic language database, enabling a user to select one or more graphics from the graphic language database that can be combined in order to convey an intended message, and combining the selected graphics into a graphical image string or graphic SMS message.

The system, method, network entity, electronic device and computer program product of exemplary embodiments of the present invention are primarily described in conjunction with mobile communications applications. It should be understood, however, that the system, method, network entity, electronic device and computer program product of embodiments of the present invention can be utilized in conjunction with a variety of other applications, both in the mobile communications industries and outside of the mobile communications industries. For example, the system, method, network entity, electronic device and computer program product of exemplary embodiments of the present invention can be utilized in conjunction with wireline and/or wireless network (e.g., Internet) applications.

### CONCLUSION

As described above and as will be appreciated by one skilled in the art, embodiments of the present invention may be configured as a system, method, network entity or electronic device. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of generating a graphical image string capable of conveying an intended message, said method comprising:
accessing a graphic language database comprising a plurality of graphics, wherein one or more annotations are associated with respective ones of the graphics;
selecting one or more graphics from the graphic language database, such that a combination of at least one of the annotations associated with the selected graphics is capable of conveying the intended message; and
combining the selected graphics into a graphical image string.

2. The method of claim 1 further comprising:
retrieving the one or more annotations associated with the selected graphics.

3. The method of claim 2 further comprising:
translating the graphical image string into a text message.

4. The method of claim 3, wherein translating the graphical image string comprises:
determining which of the one or more annotations associated with respective graphics of the graphical image string conveys the intended message;
combining the annotations determined to convey the intended message; and
formatting the combined annotations into a text message.

5. The method of claim 4, wherein determining which of the one or more annotations associated with respective graphics of the graphical image string conveys the intended message comprises:
accessing a database comprising a plurality of annotations, said database further comprising one or more attributes corresponding with respective annotations;
comparing the one or more attributes corresponding with respective annotations associated with respective graphics of the graphical image string; and
selecting at least one of the annotations for respective graphics of the graphical image string based at least in part on a comparison of the one or more attributes.

6. The method of claim 1 further comprising:
interjecting one or more words into the graphical image string.

7. The method of claim 1, wherein said intended message corresponds with a text message to be translated into a graphical image string.

8. The method of claim 7 further comprising:
extracting a context of the intended message from the text message, wherein selecting one or more graphics comprises selecting one or more graphics, such that a combination of at least one of the annotations associated with the selected graphics corresponds with the extracted context.

9. An electronic device for generating a graphical image string capable of conveying an intended message, said electronic device comprising:
a processor; and
a memory in communication with the processor, the memory storing an application executable by the processor, wherein the application is configured, upon execution, to:
access a graphic language database comprising a plurality of graphics, wherein one or more annotations are associated with respective ones of the graphics;
enable a user associated with the electronic device to select one or more graphics from the graphic language database, such that a combination of at least one of the annotations associated with the selected graphics is capable of conveying the intended message; and
combine the selected graphics into a graphical image string.

10. The electronic device of claim 9, wherein the application is further configured, upon execution, to:
retrieve the one or more annotations associated with the selected graphics.

11. The electronic device of claim 10, wherein the application is further configured, upon execution, to:
translate the graphical image string into a text message.

12. The electronic device of claim 11, wherein the application is further configured, upon execution, to:
determine which of the one or more annotations associated with respective graphics of the graphical image string conveys the intended message;
combine the annotations determined to convey the intended message; and
format the combined annotations into a text message.

13. The electronic device of claim 12, wherein the application is further configured, upon execution, to:
access a database comprising a plurality of annotations, said database further comprising one or more attributes corresponding with respective annotations;
compare the one or more attributes corresponding with respective annotations associated with respective graphics of the graphical image string; and
select at least one of the annotations for respective graphics of the graphical image string based at least in part on a comparison of the one or more attributes.

14. The electronic device of claim 9 further comprising:
an input device in communication with the processor and configured to enable the user to input one or more words into the graphical image string.

15. The electronic device of claim 9, wherein the application is further configured, upon execution, to:
receive a text message; and
translate the text message into a graphical image string.

16. The electronic device of claim 15, wherein the application is further configured, upon execution, to:
extract a context of the text message; and
select one or more graphics from the graphic language database, such that a combination of at least one of the annotations associated with the selected graphics corresponds with the extracted context.

17. An apparatus capable of converting a graphical image string into a text message, said apparatus comprising:
a processor; and
a memory in communication with the processor, the memory storing an application executable by the processor, wherein the application is configured, upon execution, to:
receive a graphical image string comprising a combination of one or more graphics selected and combined to convey an intended message;
access one or more annotations corresponding with respective graphics of the graphical image string;
select at least one of the corresponding annotations for respective graphics of the graphical image string based at least in part on a comparison of one or more attributes associated with respective annotations; and
combine the selected annotations into a text message.

18. The apparatus of claim 17, wherein the application is further configured, upon execution, to:
access a database comprising a plurality of annotations, said database further comprising one or more attributes corresponding with respective annotations;
compare the one or more attributes corresponding with respective annotations associated with respective graphics of the graphical image string; and
select at least one of the annotations for respective graphics of the graphical image string based at least in part on a comparison of the one or more attributes.

19. The apparatus of claim 17, wherein the application is further configured, upon execution, to:
receive a text message; and
translate the text message received into a graphical image string.

20. The apparatus of claim 19, wherein the application is further configured, upon execution, to:
extract a context of the text message;
access a graphic language database comprising a plurality of graphics, wherein one or more annotations are associated with respective ones of the graphics;
select one or more graphics from the graphic language database, such that a combination of at least one of the annotations associated with the selected graphics is capable of conveying the context of the text message; and
combine the selected graphics into a graphical image string.

21. The apparatus of claim 17, wherein the apparatus comprises at least one of a Common Sense Augmented Translation (CSAT) server or an electronic device.

22. A system for generating a graphical image string capable of conveying an intended message, said system comprising:
a graphic language database comprising a plurality of graphics, wherein one or more annotations are associated with respective ones of the graphics; and
an electronic device configured to access the graphic language database, the electronic device further configured to enable a user associated with the electronic device to select one or more graphics from the graphic language database, such that a combination of at least one of the annotations associated with the selected graphics is capable of conveying the intended message, and to combine the selected graphics into a graphical image string.

23. The system of claim 22 further comprising:
an annotation database comprising the annotations associated with respective ones of the graphics, wherein the electronic device is further configured to access the annotation database and to retrieve the one or more annotations associated with the selected graphics.

24. The system of claim 23, wherein the electronic device is further configured to translate the graphical image string into a text message.

25. The system of claim 23, wherein the electronic device is further configured to transmit the graphical image string, said system further comprising:
a network entity configured to receive the graphical image string and to translate the graphical image string into a text message.

26. The system of claim 24, wherein the electronic device is further configured to:
determine which of the one or more annotations associated with respective graphics of the graphical image string conveys the intended message;
combine the annotations determined to convey the intended message; and
format the combined annotations into a text message.

27. The system of claim 26 further comprising:
a database accessible by the electronic device, said database comprising a plurality of annotations and one or more attributes corresponding with respective annotations.

28. The system of claim 27, wherein the electronic device is further configured to:
access the database;
compare the one or more attributes corresponding with respective annotations associated with respective graphics of the graphical image string; and
select at least one of the annotations for respective graphics of the graphical image string based at least in part on a comparison of the one or more attributes.

29. The system of claim 22, wherein the electronic device further comprises an input device configured to enable the user to input one or more words into the graphical image string.

30. The system of claim 22, wherein the electronic device is further configured to:
receive a text message; and
translate the text message into a graphical image string.

31. The system of claim 30, wherein the electronic device is further configured to:
extract a context of the text message; and
select one or more graphics from the graphic language database, such that a combination of at least one of the annotations associated with the selected graphics corresponds with the extracted context.

32. The system of claim 25, wherein the network entity is further configured to:
receive a text message; and
translate the text message into a graphical image string.

33. The system of claim 32, wherein the network entity is further configured to:
extract a context of the text message; and
select one or more graphics from the graphic language database, such that a combination of at least one of the annotations associated with the selected graphics corresponds with the extracted context.

34. A computer programming product for generating a graphical image string capable of conveying an intended message, wherein the computer program product comprises at least one computer-readable storage medium having computer-readable program code portions stored therein, the computer-readable program code portions comprising:
a first executable portion for accessing a graphic language database comprising a plurality of graphics, wherein one or more annotations are associated with respective ones of the graphics;
a second executable portion for enabling a user associated with the electronic device to select one or more graphics from the graphic language database, such that a combination of at least one of the annotations associated with the selected graphics is capable of conveying the intended message; and
a third executable portion for combining the selected graphics into a graphical image string.

35. The computer programming product of claim 34 further comprising:
a fourth executable portion for retrieving the one or more annotations associated with the selected graphics.

36. The computer programming product of claim 35 further comprising:
a fifth executable portion for translating the graphical image string into a text message.

37. The computer programming product of claim 36 further comprising:
a sixth executable portion for determining which of the one or more annotations associated with respective graphics of the graphical image string conveys the intended message;
a seventh executable portion for combining the annotations determined to convey the intended message; and
an eighth executable portion for formatting the combined annotations into a text message.

38. The computer programming product of claim 37 further comprising:
a ninth executable portion for accessing a database comprising a plurality of annotations, said database further comprising one or more attributes corresponding with respective annotations;
a tenth executable portion for comparing the one or more attributes corresponding with respective annotations associated with respective graphics of the graphical image string; and
an eleventh executable portion for selecting at least one of the annotations for respective graphics of the graphical image string based at least in part on a comparison of the one or more attributes.

39. The computer programming product of claim 34 further comprising:
a fourth executable portion for enabling the user to input one or more words into the graphical image string.

40. The computer programming product of claim 34 further comprising:
a fourth executable portion for receiving a text message; and
a fifth executable portion for translating the text message into a graphical image string.

41. The computer programming product of claim 40 further comprising:
a sixth executable portion for extracting a context of the text message; and
a seventh executable portion for selecting one or more graphics from the graphic language database, such that a combination of at least one of the annotations associated with respective graphics selected corresponds with the extracted context.
